(19) United States
(12) Patent Application Publication
(10) Pub. No.: US 2025/0211475 A1
(43) Pub. Date: Jun. 26, 2025

(54) WIRELESS DEVICES AND METHODS FOR TRANSMITTING AND RECEIVING SIGNALS ON WIRELESS COMMUNICATION CHANNEL

(71) Applicant: HUAWEI TECHNOLOGIES CO., LTD., Shenzhen (CN)

(72) Inventor: Nassar KSAIRI, Shenzhen (CN)

(73) Assignee: HUAWEI TECHNOLOGIES CO., LTD., Shenzhen (CN)

(21) Appl. No.: 19/079,033

(22) Filed: Mar. 13, 2025

Related U.S. Application Data
(63) Continuation of application No. PCT/EP2022/075591, filed on Sep. 15, 2022.

(51) Int. Cl. H04L 27/26; H04L 5/00

(52) U.S. Cl. CPC H04L 27/2634; H04L 5/0048; H04L 27/2666

(57) ABSTRACT

A wireless transmitting device to transmit a signal on a wireless communication channel. The wireless transmitting device obtains a set of Mᵤ input symbols from a user u and apply a precoder to generate a set of precoded input symbols. The precoder includes an Mᵤ-point discrete affine Fourier transform (DAFT) based on a bivariate polynomial that includes a first quadratic term of the time index and a second quadratic term of the input symbol index associated with a same coefficient based on a system parameter. The wireless transmitting device further apply an N-point inverse discrete affine Fourier transform (IDAFT) to a vector formed by placing the Mᵤ precoded input symbols on Mᵤ consecutive entries of an N-long vector with the entries ranges assigned to different users being non-overlapping. Finally, the wireless transmitting device is configured to transmit the signal on the wireless communication channel with low PAPR performance.

### CROSS-REFERENCE TO RELATED APPLICATIONS

This is a continuation of International Patent Application No. PCT/EP2022/075591, filed on Sep. 15, 2022, the disclosure of which is hereby incorporated by reference in its entirety.

### TECHNICAL FIELD

This invention generally relates to a wireless communication system, and in particular to a wireless transmitting device, a wireless receiving device, and corresponding methods for transmitting and receiving signals on a wireless communication channel.

### BACKGROUND

Generally, power amplifiers, such as the power amplifiers of wireless terminals, such as a transmitting terminal or a receiving terminal, and other devices that operate at high carrier frequencies cause non-linear distortions while transmitting input signals above a certain input power level. Thus, in such cases, it is difficult to achieve high signal-to-quantization-noise ratio (SQNR) values when analog-to-digital convertors (ADCs) and digital-to-analog convertors (DACs) are used with signals having large peak-to-average power ratio (PAPR). Moreover, in high-mobility scenarios, such as in scenarios where the transmitting terminal or the receiving terminal or both are moving rapidly with respect to each other, then transmitted signals are received corrupted with relatively large values of Doppler frequency shift. In these scenarios, different contributions in the received signal originating from different reflecting and scattering objects in the environment are typically received with different values of the Doppler frequency shift. The difference between the smallest and the largest Doppler shift in the received signal is called the Doppler frequency spread. Such wireless channels are time-varying and are referred to as doubly dispersive because they involve both dispersions in time, due to the delay spread, and in frequency, due to the Doppler spread. In the existing wireless systems, the larger the Doppler spread, the higher the challenge it poses to data detection at the receiving terminals.

Conventionally, certain attempts have been made to remove the challenge of data detection at the receiving terminals, such as by using orthogonal frequency division multiplexing (OFDM) waveforms. However, such OFDM waveforms are not designed for mobility (due to the loss of orthogonality among OFDM subcarriers that Doppler frequency shifts cause) and high-frequency impairments (due to the typically degraded peak-to-average power ratio (PAPR) performance of OFDM signals, which is not desirable as we explained earlier). Thus, OFDM waveforms can only be tuned to compensate for these effects, such as by making the OFDM symbol shorter in order to conserve orthogonality in presence of Doppler frequency shifts. Moreover, compensation is not always the best option as it could cause losses in spectral efficiencies, such as in the OFDM waveforms or in other performance metrics. Therefore, there exists a technical problem to design new waveforms that outperform, in terms of reliability, achievable data rate or latency, and larger Doppler frequency spread with improved PAPR performance.

Therefore, in light of the foregoing discussion, there exists a need to overcome the aforementioned drawbacks associated with the conventional approaches for the wireless transmitting device and wireless receiving device.

### SUMMARY

The present disclosure provides a wireless transmitting device, a wireless receiving device, and methods for transmitting and receiving signals on a wireless communication channel. The present disclosure provides a solution to the existing problem of how to remove the challenge of data detection and how to design new waveforms with reduced peak-to-average power ratio (PAPR) performance. An aim of the present disclosure is to provide a solution that overcomes at least partially the problem encountered in the prior art and provides an improved wireless transmitting device, an improved wireless receiving device, and improved methods for transmitting and receiving the signals on the wireless communication channel. Furthermore, the signal corresponds to a discrete affine Fourier transform (DAFT)-spread-affine frequency division multiplexing (AFDM) signal with low-peak to average power ratio (PAPR) performance. DAFT is a generalization of discrete Fourier transform (DFT) and a linear transform characterized by a couple of parameters (c₁, c₂). AFDM is a waveform based on DAFT. An AFDM transmitter uses an inverse discrete affine Fourier transform (IDAFT) that maps the symbols at its input to discrete-time chirp signals parametrized with (c₁, c₂) at its output. Each such chirp signal has a phase which is a bivariate polynomial that comprises a first coefficient, c₁, of a quadratic term of the chirp signal time index n and a second coefficient, c₂, of a quadratic term of the input symbol index m. AFDM can provide spreading (or coverage) gain that is robust to mobility, carrier frequency offset (CFO), and phase noise. This robustness is achieved when channel estimation at the receiver side is performed based on DAFT domain pilots i.e., based on reference symbols at the input of the IDAFT module of the AFDM transmitter that is mapped by this module to chirp pilot signals to be transmitted on the wireless channel. Therefore, AFDM is suitable for communications over doubly dispersive channels and at high carrier frequencies. However, it has a PAPR performance similar to that of OFDM. DAFT-s-AFDM has a better PAPR performance than both AFDM and OFDM while inheriting the advantages of AFDM for communications over doubly dispersive channels and at high carrier frequencies.

One or more objectives of the present disclosure are achieved by the solutions provided in the enclosed independent claims. Advantageous implementations of the present disclosure are further defined in the dependent claims.

In one aspect, the present disclosure provides a wireless transmitting device that is configured to transmit a signal on a wireless communication channel. The wireless transmitting device is configured to obtain a set of Mᵤ input symbols from a user u, where u∈{1, . . . , U} and U≥1. Further, the wireless transmitting device is configured to apply a precoder for the set of Mᵤ input symbols to generate a set of precoded input symbols. The precoder comprises a Mᵤ-point discrete affine Fourier transform (DAFT), based on chirp carriers the phase of each of which is a bivariate polynomial of input symbol index m and time index n. The bivariate polynomial comprises a first quadratic term of the time index and a second quadratic term of the input symbol index. The first quadratic term of the time index and the second quadratic term of the input symbol index is associated with a same coefficient c based on a system parameter. The wireless transmitting device is configured to apply an N-point inverse discrete affine Fourier transform (IDAFT), to a vector formed by placing the Mᵤ precoded input symbols on Mᵤ consecutive entries of an all-zeros N-long vector with the entries ranges assigned to different users u being non-overlapping. The N-point IDAFT is based on chirp carriers the phase of each of which is a bivariate polynomial of precoded input symbol index and the time index. The bivariate polynomial comprises a first quadratic term of the time index and a second quadratic term of the precoded input symbol index, the first quadratic term of the time index and the second quadratic term of the precoded input symbol index being associated with the same coefficient c, where N≥max{Mᵤ}u∈{1, . . . , U} and transmit the signal on the wireless communication channel. The signal resulting from the combined effect of the Mᵤ-point DAFT and the N-point IDAFT is a single-carrier signal with a chirped Dirichlet pulse shape.

The wireless transmitting device is configured to transmit the signal, such as a discrete affine Fourier transform-spread-affine frequency division multiplexing (DAFT-s-AFDM) signal that is a single-carrier signal with a chirped Dirichlet pulse shape. Beneficially as compared to conventional approaches such as AFDM and OFDM, the DAFT-s-AFDM signal has lower, hence improved, PAPR values. When compared to other conventional single-carrier approaches such as DFT-s-OFDM, it provides orthogonality in the DAFT-domain i.e., when DAFT transformation is applied at the receiver side. In other words, different instances of the wireless transmitting device of the wireless communication system can be used to generate chirped single-carrier signals carrying data from a number of user terminals and occupying the same time and frequency resources (due to the chirping while the signals corresponding to these different users are orthogonally separable at the receiver e.g., base station, side. Also, DAFT-s-AFDM provides orthogonal separability of data and DAFT-domain reference signals and between different DAFT-domain reference signals that might be needed for channel estimation and other possible purposes when transformed into the chirp domain constituted by applying the DAFT transformation. The wireless transmitting device can thus be used for time-varying channel estimation with DAFT-domain pilot symbols such as in AFDM, due to which the DAFT-s-AFDM signal inherits AFDM advantages in terms of enhanced time-varying channel estimation performance and robustness in presence of impairments such as CFO.

In an implementation form, the wireless transmitting device is configured to transmit an indication of at least one system parameter with the signal (e.g., the value of N or the DAFT coefficient c).

The indication of at least one system parameter is used for channel estimation and data detection.

In a further implementation form, the wireless transmitting device is configured to form the set of Mᵤ input symbols by embedding transform-domain pilot symbols among non-pilot input symbols.

In this implementation, the set of Mᵤ input symbols includes different embedded transform-domain pilot symbols and non-pilot input symbols.

In a further implementation form, the wireless transmitting device is further configured to form the set of Mᵤ input symbols by inserting guard samples between different embedded pilot symbols and between embedded pilot symbols and non-pilot input symbols.

The guard samples are used to separate each pilot symbol from other pilot symbols, such as to separate different embedded pilot symbols from each other and also separate the embedded pilot symbols from the non-pilot input symbols.

In a further implementation, the guard samples have non-zero values.

The non-zero values of the guard samples occupy an interval in the time domain and provide low peak-to-average power ratio (PAPR) performance.

In another aspect, the present disclosure provides a method for transmitting a signal on a wireless communication channel. The method comprises obtaining a set of Mᵤ input symbols from a user u, where u∈{1, . . . , U} and U≥1. Further, applying a precoder for the set of Mᵤ input symbols to generate a set of precoded input symbols, the precoder comprising a Mᵤ-point discrete affine Fourier transform (DAFT), based on chirp carriers the phase of each of which is a bivariate polynomial of input symbol index and the time index. The bivariate polynomial comprises a first quadratic term of the time index and a second quadratic term of the input symbol index, the first quadratic term of the time index and second quadratic term of the time index being associated with a same coefficient c based on a system parameter and a channel parameter. The method is configured for applying an N-point inverse discrete affine Fourier transform (IDAFT) to a vector formed by placing the Mᵤ precoded input symbols on Mᵤ consecutive entries of an all-zeros N-long vector with the entries ranges assigned to different users u being non-overlapping to generate the signal, where the N-point IDAFT is based on chirp carriers the phase of each of which is a bivariate polynomial of precoded input symbol index and time index, the bivariate polynomial comprising a first quadratic term of the time index and a second quadratic term of the precoded input symbol index, the first quadratic term of the time index and the second quadratic term of the precoded input symbol index being associated with the same coefficient c, where N≥max{Mᵤ}u∈{1, . . . , U} and transmitting the signal on the wireless communication channel.

The method achieves all the advantages and technical effects of the wireless transmitting device of the present disclosure.

In yet another aspect, the present disclosure provides a wireless receiving device configured to receive a signal from a wireless communication channel. The wireless receiving device is configured to receive the signal. The signal comes from U user devices, {1, . . . , U} and U≥1. The user device {1, . . . , U} is a wireless transmitting device. Further, the wireless receiving device is configured to apply an N-point discrete affine Fourier transform (DAFT), to N received symbols to generate U sets, each comprising Mᵤ DAFT-domain symbols. The N-point DAFT is based on chirp carriers the phase of each of which is a bivariate polynomial of symbol index and time index. The bivariate polynomial comprises a first quadratic term of the time index and a second quadratic term of the symbol index. The first quadratic term of the time index and the second quadratic term of the symbol index is associated with a same coefficient c based on a system parameter, and where N≥max{Mᵤ}u∈{1, . . . , U} and apply an inverse precoder for each of the set comprising DAFT-domain symbols to generate U sets of estimated input symbols. The inverse precoder comprises a Mᵤ-point inverse discrete affine Fourier transform (IDAFT), based on chirp carriers the phase of each of which is a bivariate polynomial of the DAFT-domain symbol index and the time index. The bivariate polynomial comprises a first quadratic term of the time index and a second quadratic term of the DAFT-domain symbol index. The first quadratic term of the time index and the second quadratic term of the DAFT-domain symbol index is associated with the same coefficient c.

The wireless receiving device is configured to receive the signal, such as a discrete affine Fourier transform-spread-affine frequency division multiplexing (DAFT-s-AFDM) signal that is a single-carrier signal with a chirped Dirichlet pulse shape. Beneficially, the DAFT-s-AFDM signal has low PAPR values. It also provides orthogonality in the DAFT-domain i.e., when DAFT transformation is applied at the receiver side.

In another aspect, the present disclosure provides a method for receiving a signal from a wireless communication channel. The method comprising receiving the signal, wherein the signal comprises U set of Mᵤ received symbols for each user u, where u∈{1, . . . , U} and U≥1. Further, applying an N-point discrete affine Fourier transform (DAFT) to an aggregation of the U sets of Mᵤ received symbols, to generate U sets each comprising Mᵤ DAFT-domain symbols, the N-point DAFT is based on chirp carriers the phase of each of which is a bivariate polynomial of symbol index and time index. The bivariate polynomial comprises a first quadratic term of the time index and a second quadratic term of the symbol index. The first quadratic term of the time index and the second quadratic term of the symbol index is associated with a same coefficient c based on a system parameter and a channel parameter, and where N≥max{Mᵤ}_{u∈{1, . . . , U}}and applying an inverse precoder for each of the set comprising DAFT-domain symbols to generate U sets of estimated symbols. The inverse precoder comprising a Mᵤ-point inverse discrete affine Fourier transform (IDAFT), based on chirp carriers the phase of each of which is a bivariate polynomial of DAFT-domain symbol index and time index, the bivariate polynomial comprising a first quadratic term of the time index and a second quadratic term of the DAFT-domain symbol index. The first quadratic term of the time index and the second quadratic term of the DAFT-domain symbol index are associated with the same coefficient c.

The method achieves all the advantages and technical effects of a wireless receiving device of the present disclosure.

It is to be appreciated that all the aforementioned implementation forms can be combined.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings.

For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

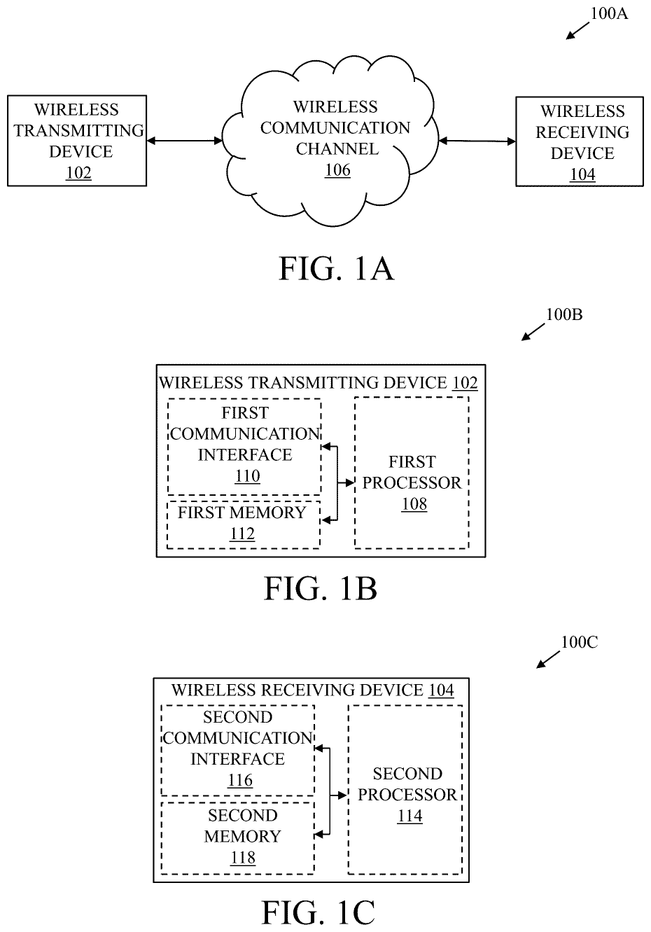

a. FIG. 1A is a network environment diagram of a wireless communication system, in accordance with an embodiment of the present disclosure;

b. FIGS. 1B and 1C are different block diagrams that depict a wireless transmitting device and a wireless receiving device, in accordance with an embodiment;

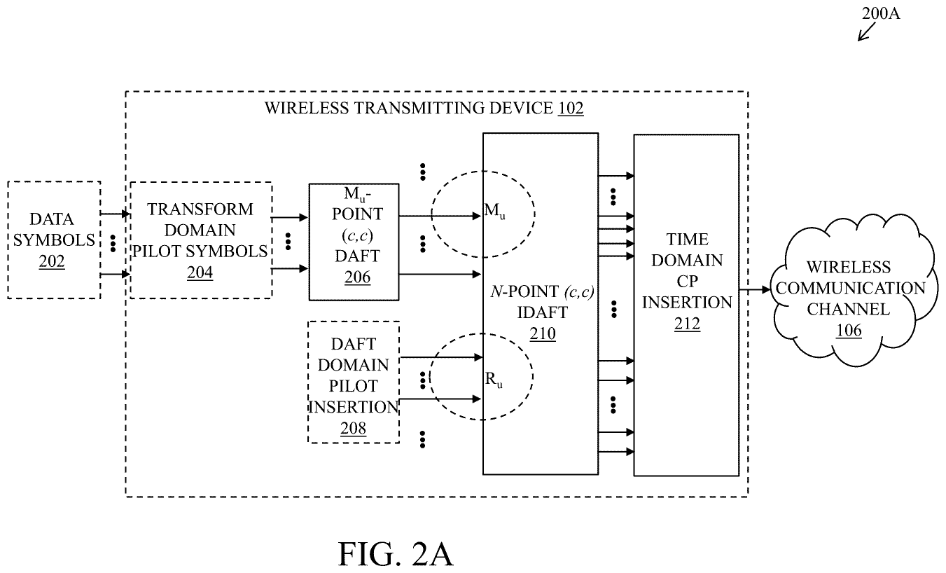

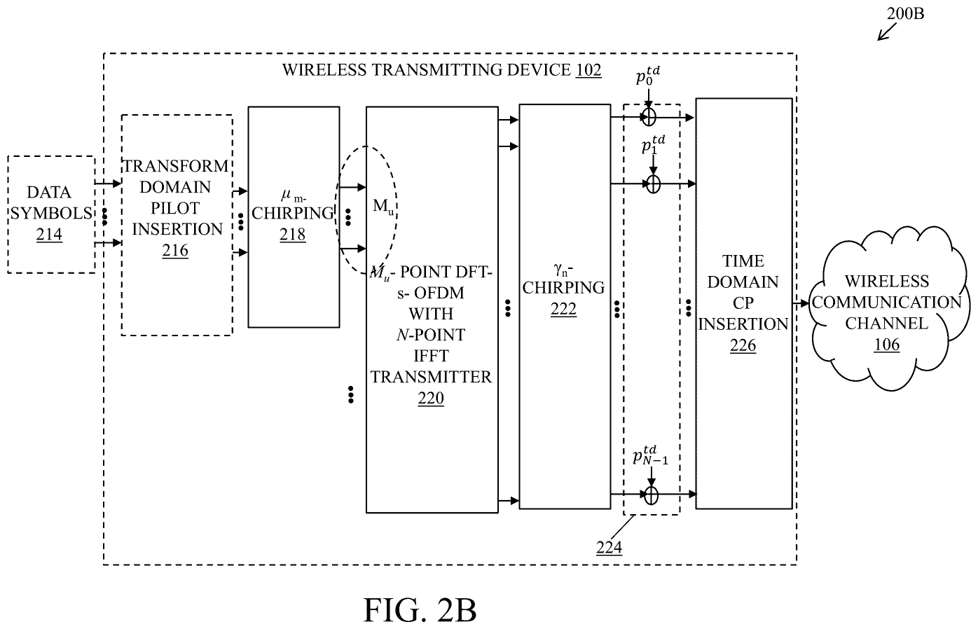

c. FIG. 2A is a diagram that depicts transmission of signals by a wireless transmitting device through a wireless communication channel, in accordance with an embodiment;

d. FIG. 2B is a diagram that depicts transmission of signals by a wireless transmitting device through a wireless communication channel, in accordance with another embodiment;

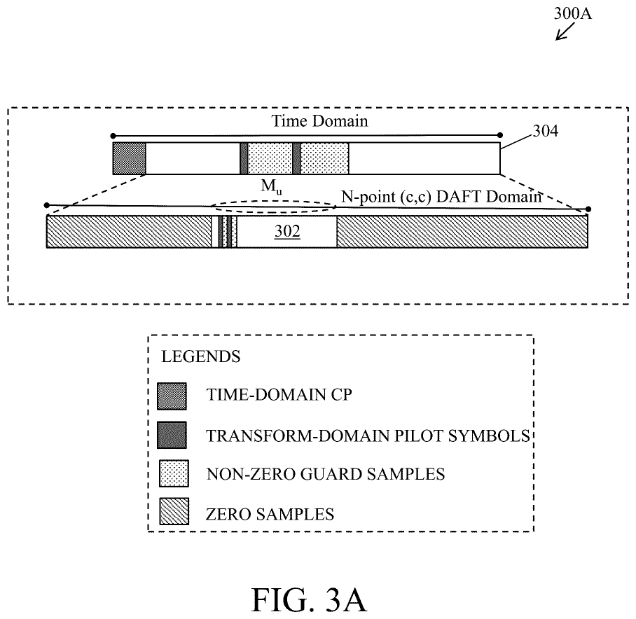

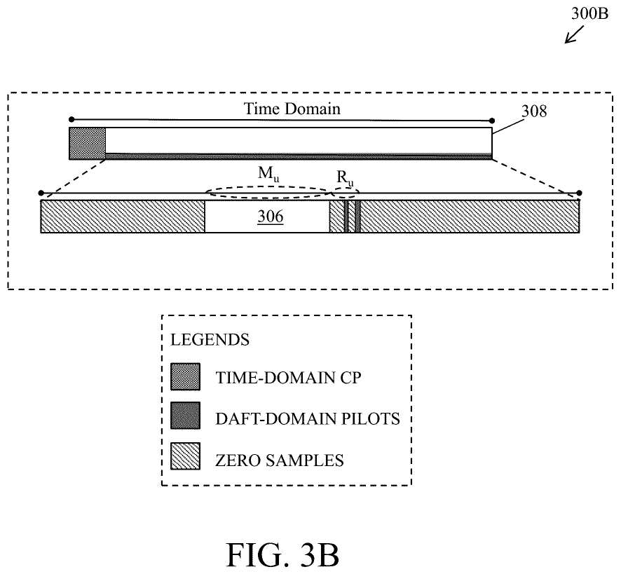

e. FIG. 3A is a diagram that depicts transform-domain (embedded) pilot symbols and guard samples, in accordance with an embodiment;

f. FIG. 3B is a diagram that depicts DAFT-domain (non-embedded) pilot symbols and guard samples, in accordance with an embodiment;

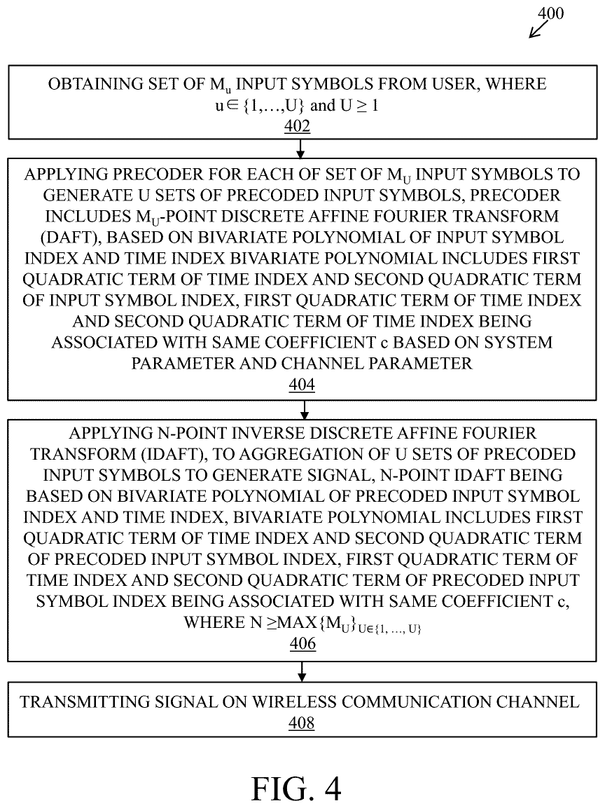

g. FIG. 4 is a diagram that depicts a flowchart of a method for transmitting a signal on a wireless communication channel, in accordance with an embodiment;

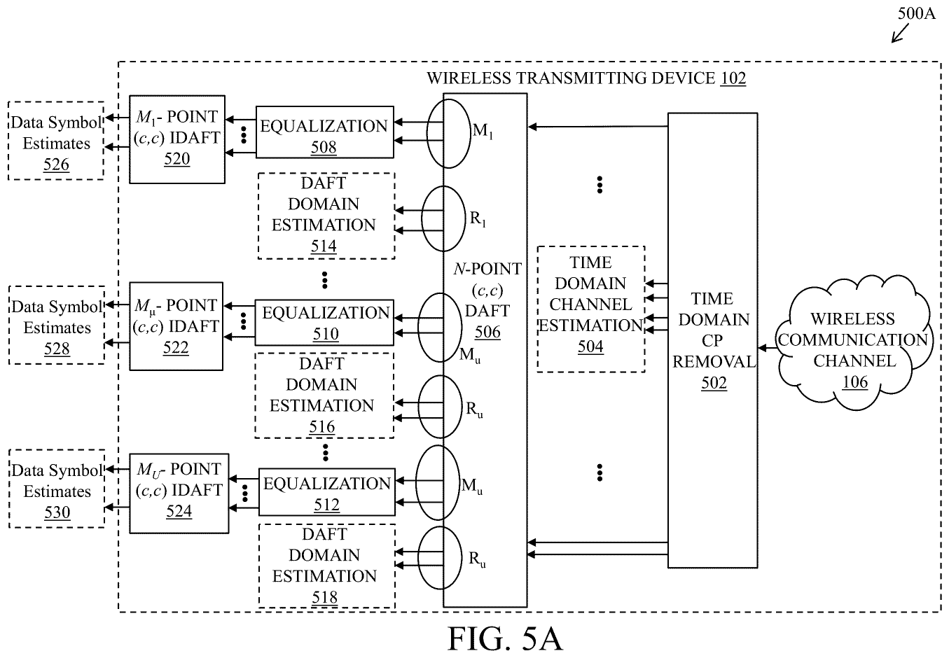

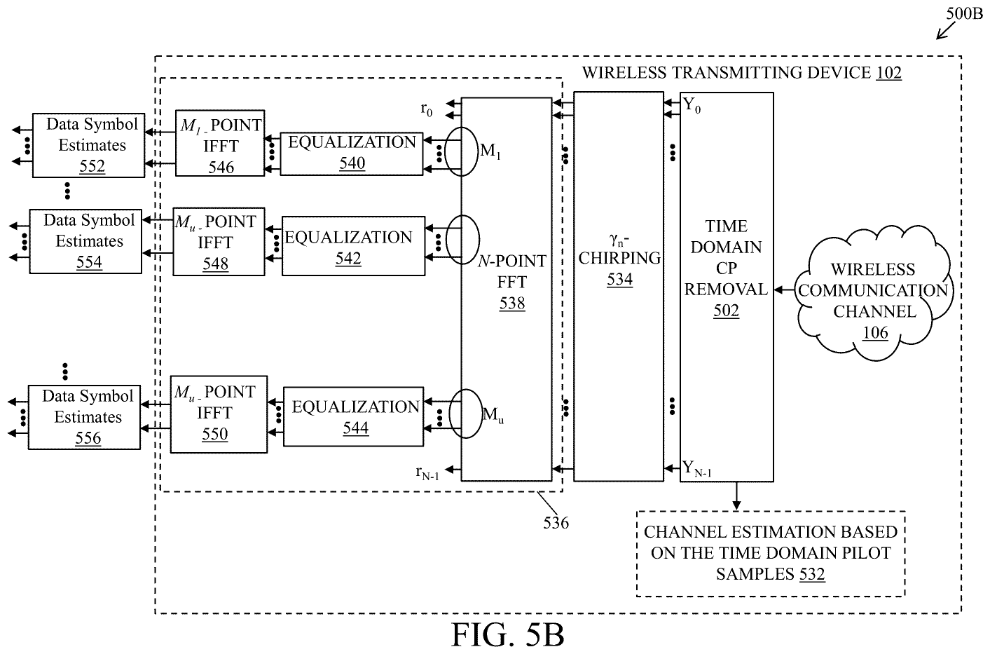

h. FIG. 5A is a diagram that depicts a wireless receiving device to receive a signal from a wireless communication channel, in accordance with an embodiment;

i. FIG. 5B is a diagram that depicts a wireless receiving device to receive a signal from a wireless communication channel, in accordance with another embodiment; and

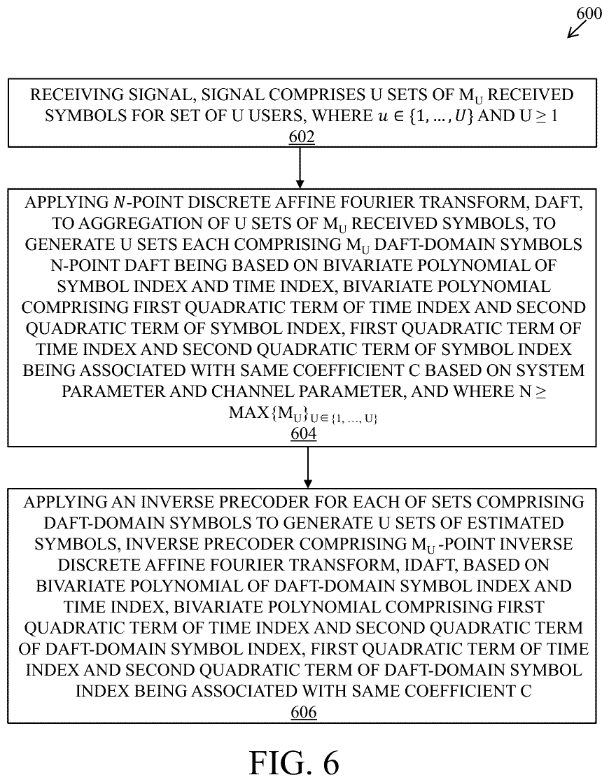

j. FIG. 6 is a diagram that depicts a flowchart of a method for receiving a signal on a wireless communication channel, in accordance with an embodiment.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

FIG. 1A is a network environment diagram of a wireless communication system, in accordance with an embodiment of the present disclosure. With reference to FIG. 1A, there is shown a network environment of a wireless communication system 100A that includes a wireless transmitting device 102 and a wireless receiving device 104. There is further shown a wireless communication channel 106.

The wireless communication system 100A includes the wireless transmitting device 102, the wireless receiving device 104, and the wireless communication channel 106. The wireless transmitting device 102 is configured to transmit one or more signals to the wireless receiving device 104 via the wireless communication channel 106. The wireless transmitter device 102 is a user terminal transmitting in the uplink. Moreover, U transmitter devices are used in the uplink and each includes one set of Mᵤ data symbols. Examples of the wireless transmitting device 102 include but are not limited to, a transmitter, a sender, a transceiver, an encoder, a user terminal of a cellular network, and a customized hardware for wireless telecommunication, or any other portable or non-portable electronic device.

The wireless receiving device 104 is configured to receive the signal from the wireless transmitting device 102, via the wireless communication channel 106. Examples of the wireless receiving device 104 may include but are not limited to, a receiver, a decoder, a transceiver, a base station or an access point in a cellular network, and the like.

The wireless communication channel 106 includes a medium (e.g., a communication channel) through which one or more transmitting devices, such as the wireless transmitting device 102, potentially communicate with the wireless receiving device 104. Examples of the wireless communication channel 106 may include, but are not limited to, a cellular network, a wireless sensor network (WSN), a cloud network, a Local Area Network (LAN), a vehicle-to-network (V2N) network, a Metropolitan Area Network (MAN), and the like.

The wireless transmitting device 102 (herein may also be referred to as a device 102) is configured to obtain a set of Mᵤ input symbols from a user u, where u∈{1, . . . , U} and U≥1. The wireless transmitting device 102 is further configured to apply a precoder for the set of Mᵤ input symbols to generate a set of precoded input symbols. The precoder includes an Mᵤ-point discrete affine Fourier transform (DAFT), based on chirp carriers the phase of each of which is a bivariate polynomial of input symbol index m and time index n so that when fed with Mᵤ symbols {sₘ}_{m=0 . . . M}_{ᵤ}₋₁ at its input, the precoder produces at its output

$${M}_{u} samples {\{ \frac{1}{\sqrt{{M}_{u}}} {\sum }_{m = 0}^{{M}_{u} - 1} {s}_{m} {e}^{- ι 2 π p ( m , n )} \}}_{n = 0 … {M}_{u} - 1} .$$

Further, the bivariate polynomial includes a first quadratic term of the time index and a second quadratic term of the input symbol index so that

$$p ( m , n ) = {c}_{1} {n}^{2} + {c}_{2} {m}^{2} - \frac{n m}{{M}_{u}} .$$

Moreover, the first quadratic term of the time index and the second quadratic term of the input symbol index is associated with a same coefficient c based on a system parameter i.e., c₁=c₂=c. Thereafter, the wireless transmitting device 102 is configured to apply an N-point inverse discrete affine Fourier transform (IDAFT), to a vector formed by placing the Mᵤ precoded input symbols on Mᵤ consecutive entries of an all-zeros N-long vector with the entries ranges assigned to different users u being non-overlapping. Moreover, the N-point IDAFT is based on chirp carriers the phase of each of which is a bivariate polynomial

$$q ( m , n ) = {c}_{1} {n}^{2} + {c}_{2} {m}^{2} - \frac{n m}{N}$$

of precoded input symbol index m and time index n, the bivariate polynomial includes a first quadratic term of the time index and a second quadratic term of the precoded input symbol index so that, when fed with the samples of the N-long vector {vₘ}_{m=0 . . . M}_{ᵤ}₋₁ at its input, it produces at its output

$$N samples {\{ \frac{1}{\sqrt{N}} {\sum }_{m = 0}^{N - 1} {v}_{m} {e}^{ι 2 π q ( m , n )} \}}_{n = 0 … N - 1} .$$

Furthermore, the first quadratic term of the time index and the second quadratic term of the precoded input symbol index is associated with the same coefficient c₁=c₂=c, where N≥max{Mᵤ}_{u∈{1, . . . , U}}. In an example, the coefficient c is equal to 1/2N. Thereafter, the wireless transmitting device 102 is configured to transmit the signal on the wireless communication channel 106 to another user, such as to the wireless receiving device 104.

The wireless receiving device 104 (herein may also be referred to as a device 104) is configured to receive the signal from the wireless communication channel 106. The wireless receiving device 104 is configured to receive the signal from U user devices, {1, . . . , U} and U≥1, such as from the wireless transmitting device 102. In an example, one or more user devices are used configured to provide multiple non-overlapping inputs to their respective N-point IDAFT modules (e.g., AFDM modulators), and each user input is precoded before being fed to the N-point IDAFT. Thereafter, the wireless receiving device 104 is configured to apply an N-point discrete affine Fourier transform (DAFT), to N received symbols to generate U sets, each including Mᵤ DAFT-domain symbols. In addition, the N-point DAFT is based on chirp carriers the phase of each of which is a bivariate polynomial of symbol index and time index, the bivariate polynomial includes the first quadratic term of the time index and the second quadratic term of the symbol index. Moreover, the first quadratic term of the time index and the second quadratic term of the symbol index is associated with the same coefficient c based on the system parameter, and where N≥max{Mᵤ}_{u∈{1, . . . , U}}. The signal resulting from the combined effect of the Mᵤ-point DAFT and the N-point IDAFT is a single-carrier signal with a chirped Dirichlet pulse shape. Thereafter, the wireless receiving device 104 is configured to apply an inverse precoder for each of the set comprising DAFT-domain symbols to generate a set of estimated input symbols. Furthermore, the inverse precoder includes an Mᵤ-point inverse discrete affine Fourier transform (IDAFT), based on chirp carriers the phase of each of which is a bivariate polynomial of DAFT-domain symbol index and the time index. In addition, the bivariate polynomial includes the first quadratic term of the time index and the second quadratic term of the DAFT-domain symbol index. Moreover, the first quadratic term of the time index and the second quadratic term of the DAFT-domain symbol index is associated with the same coefficient c. DAFT is a generalization of discrete Fourier transform (DFT) and a linear transform characterized by a couple of parameters (c₁, c₂). AFDM is a waveform based on DAFT. An AFDM transmitter uses an inverse discrete affine Fourier transform (IDAFT) that maps the symbols at its input to discrete-time chirp signals parametrized with (c₁, c₂) at its output. Each such chirp signal has a phase which is a bivariate polynomial that includes a first coefficient, c₁, of a quadratic term of the chirp signal time index n and a second coefficient, c₂, of a quadratic term of the input symbol index m. AFDM can provide spreading (or coverage) gain that is robust to mobility, carrier frequency offset (CFO), and phase noise. Such robustness is achieved when channel estimation at the receiver side is performed based on DAFT domain pilots that is based on reference symbols at the input of the IDAFT module of the AFDM transmitter that is mapped by this module to chirp pilot signals to be transmitted on the wireless channel. Therefore, AFDM is suitable for communications over doubly dispersive channels and at high carrier frequencies. However, AFDM has a PAPR performance similar to that of OFDM. DAFT-s-AFDM has a better PAPR performance than both AFDM and OFDM while inheriting the advantages of AFDM for communications over doubly dispersive channels and at high carrier frequencies.

The wireless transmitting device 102, and the wireless receiving device 104 of the wireless communication system 100A provides improved affine frequency division multiplexing (AFDM) signal or waveforms for doubly dispersive channels, which can be used to generate multi-chirp signals characterized by a number of tunable parameters. The AFDM signal can achieve the full diversity of linear time-varying (LTV) channels with low pilot overhead. The wireless communication system 100A further provides a modified AFDM waveform and transceiver design, namely DAFT-s-AFDM (i.e., DAFT-spread-AFDM), that allows to achieve the advantages of AFDM with improved peak-to-average power ratio (PAPR) performance. In other words, the wireless communication system 100A is used to provide the DAFT-s-AFDM signal for Low-PAPR wireless transmission.

FIGS. 1B and 1C are different block diagrams that depict a wireless transmitting device and a wireless receiving device, in accordance with an embodiment of the present disclosure. With reference to FIG. 1B there is shown a block diagram 100B of the wireless transmitting device 102 that includes a first processor 108, a first communication interface 110, and a first memory 112. With reference to FIG. 1C there is shown a block diagram 100C of the wireless receiving device 104 that includes a second processor 114, a second communication interface 116, and a second memory 118.

The first communication interface 110 is used by the wireless transmitting device 102 to communicate with the wireless receiving device 104 through the wireless communication channel 106. Moreover, the second communication interface 116 is used by the wireless receiving device 104 to communicate with the wireless transmitting device 102 through the wireless communication channel 106. Examples of implementation of the first communication interface 110, and the second communication interface 116 may include but are not limited to a network interface, a computer port, a network socket, a network interface controller (NIC), and any other network interface device.

The first processor 108 is configured to transmit the signal from the wireless transmitting device 102 through the wireless communication channel 106. Moreover, the second processor 114 is configured to receive the signal from the wireless transmitting device 102 through the wireless communication channel 106. Examples of implementation of the first processor 108, and the second processor 114 may include but are not limited to a central data processing device, a microprocessor, a microcontroller, a complex instruction set computing (CISC) processor, an application-specific integrated circuit (ASIC) processor, a reduced instruction set (RISC) processor, a very long instruction word (VLIW) processor, a state machine, and other processors or control circuitry.

Each of the first memory 112 and the second memory 118 are configured to store the set of Mᵤ input symbols. Examples of implementation of the first memory 112 and the second memory 118 may include, but are not limited to, Electrically Erasable Programmable Read-Only Memory (EEPROM), Dynamic Random-Access Memory (DRAM), Random Access Memory (RAM), Read-Only Memory (ROM), Hard Disk Drive (HDD), Flash memory, a Secure Digital (SD) card, Solid-State Drive (SSD), and/or central processing unit (CPU) cache memory.

FIG. 2A is a diagram that depicts transmission of signals by a wireless transmitting device through a wireless communication channel, in accordance with an embodiment. FIG. 2A is described in conjunction with elements from FIGS. 1A and 1B. With reference to FIG. 2A, there is shown a diagram 200A that includes a series of operations from 202-to-212. The wireless transmitting device 102 (of FIG. 1A) is configured to execute the operations shown in the diagram 200A.

In operation, the wireless transmitting device 102 (herein simply can be referred to as a device 102) is configured to obtain a set of Mᵤ input symbols from a user u, where u∈{1, . . . , U} and U≥1. For example, at operation 202, the wireless transmitting device 102 is configured to obtain the set of Mᵤ input symbols or the data symbols from the user u. In an implementation, the set of Mᵤ input symbols may be obtained from different users, such as from a user 1, a user 2, or a user U. In an example, the user u may also include a device that is configured to transmit the set of Mᵤ input symbols to the wireless transmitting device 102.

In accordance with an embodiment, the wireless transmitting device 102 is further configured to form the set of Mᵤ input symbols by embedding transform-domain pilot symbols among non-pilot input symbols. For example, at operation 204, the wireless transmitting device 102 is configured to embed the transform-domain pilot symbols among the non-pilot input symbols (e.g., input symbols) to form the set of Mᵤ input symbols. Therefore, the set of Mᵤ input symbols includes different embedded transform-domain pilot symbols and non-pilot input symbols (e.g., input symbols). In accordance with another embodiment, the wireless transmitting device 102 is further configured to form the set of Mᵤ input symbols by inserting guard samples between different embedded pilot symbols and between embedded pilot symbols and the non-pilot input symbols. In an example, the first processor 108 is used by the wireless transmitting device 102 to insert the guard samples between different embedded pilot symbols and also between the embedded pilot symbols and the non-pilot input symbols, as further shown in FIG. 3A. The guard samples are used to separate each pilot symbol from other pilot symbols, such as to separate different embedded pilot symbols from each other and also separate the embedded pilot symbols from the non-pilot input symbols. In an example, the guard samples may also act as safeguards for the embedded pilot symbols, such as to protect from interference. As a result, the guard samples are used to prevent interference between two different pilot symbols. In such embodiments, the guard samples have non-zero values. Therefore, the guard samples may also be referred to as constant-amplitude samples that may occupy an interval in the time domain and provide low peak-to-average power ratio (PAPR) performance.

The wireless transmitting device 102 is further configured to apply a precoder for the of Mᵤ input symbols to generate a set of precoded input symbols, and the precoder includes an Mᵤ-point discrete affine Fourier transform (DAFT), based on chirp carriers the phase of each of which is a bivariate polynomial of input symbol index m and time index n. For example, at operation 206, the wireless transmitting device 102 is configured to apply the Mᵤ-point DAFT on the set of Mᵤ input symbols to generate a set of precoded input symbols, and the Mᵤ-point DAFT is based on chirp carriers the phase of each of which is the bivariate polynomial p(m, n) of the input symbol index m and the time index n so that, when fed with Mᵤ symbols {sₘ}_{m=0 . . . M}_{ᵤ}₋₁ at its input, it produces at its output Mᵤ samples

$${\{ \frac{1}{\sqrt{{M}_{u}}} {\sum }_{m = 0}^{{M}_{u} - 1} {s}_{m} {e}^{- ι 2 π p ( m , n )} \}}_{n = 0 … {M}_{u} - 1} .$$

In an implementation, the wireless transmitting device 102 is configured to utilize a precoder that provides improved peak-to-average power ratio (PAPR) values. Further, the bivariate polynomial includes a first quadratic term of the time index n and a second quadratic term of the input symbol index m. Moreover, the first quadratic term of the time index n and the second quadratic term of the input symbol index m is associated with a same coefficient c based on a system parameter. In an example, the first quadratic term of the time index n is associated with a coefficient c1, and the second quadratic term of the input symbol index m is associated with a coefficient c2, and c1=c2=c (i.e., same coefficient) so that

$$p ( m , n ) = {c}_{1} {n}^{2} + {c}_{2} {m}^{2} - \frac{n m}{{M}_{u}} .$$

In accordance with an embodiment, the wireless transmitting device 102 is further configured to append the transmitted signal with a set of Rᵤ DAFT-domain pilot symbols by placing the Rᵤ pilot symbols on Rᵤ consecutive entries of the vector at the input of the N-point IDAFT that are non-overlapping with the entries occupied by the outputs of the Mᵤ-point DAFT. For example, at operation 208, the wireless transmitting device 102 is configured to append the transmitted signal with a set of Rᵤ DAFT-domain pilot symbols (i.e., perform DAFT-domain pilot insertion) by placing the Rᵤ pilot symbols on the Ru consecutive entries of the vector at the input of the N-point IDAFT that are non-overlapping with the entries occupied by the outputs of the Mᵤ-point DAFT (i.e., Mᵤ-point (c, c) DAFT). In such embodiment, the wireless transmitting device 102 is further configured to insert the guard samples between predefined symbols to form the set of Rᵤ appended DAFT-domain pilot symbols and in the vector at the input of the N-point IDAFT between the set of Mᵤ precoded input symbols and the set of Rᵤ appended DAFT-domain pilot symbols. In an implementation, a number of inputs of the N-point IDAFT (i.e., IDAFT module) are forming the set of [symbol] ᵤ⊂{0, . . . , N−1} that can be dedicated to transmitting a number N_{p,u}<| [symbol] ᵤ| of pilot symbols. In an example, the difference between the modulus of the subset [symbol] ᵤ, and the number N_{p,u} (i.e., | [symbol] ᵤ|−N_{p,u}) corresponds to the number of the guard samples that are required for channel estimation at the receiver side, such as at the wireless receiving device 104. In an example, such pilot symbols may be referred to as “non-embedded” since they are not embedded with the data symbols in the transform domain and also as DAFT-domain since such pilot symbols are directly fed to the N-point IDAFT (i.e., IDAFT module) and hence lie in the domain of the DAFT.

The wireless transmitting device 102 is further configured to apply an N-point inverse discrete affine Fourier transform (IDAFT), to a vector formed by placing the Mᵤ precoded input symbols on Mᵤ consecutive entries of an all-zeros N-long vector with the entries ranges assigned to different users u is non-overlapping. Firstly, the wireless transmitting device 102 is configured to place the Mᵤ precoded input symbols on the Mᵤ consecutive entries of an all-zeros N-long vector with the entry ranges assigned to different users u being non-overlapping to form the vector. Thereafter, at operation 210, the wireless transmitting device 102 is further configured to apply the N-point IDAFT to the vector. Moreover, the N-point IDAFT is based on chirp carriers the phase of each of which is the bivariate polynomial of the precoded input symbol index and the time index, the bivariate polynomial includes a first quadratic term of the time index and a second quadratic term of the precoded input symbol index. Furthermore, the first quadratic term of the time index and the second quadratic term of the precoded input symbol index is associated with the same coefficient c, where N≥max{Mu}u∈{1, . . . , U}.

In accordance with an embodiment, the wireless transmitting device 102 is further configured to append the signal with a chirp periodic prefix or a cyclic prefix after applying the N-point IDAFT to generate the signal. The signal resulting from the combined effect of the Mᵤ-point DAFT and the N-point IDAFT is a single-carrier signal with a chirped Dirichlet pulse shape. The chirp periodic prefix is known from the art on chirp waveforms and plays for AFDM signals, in which the frequency of the chirp carriers

$${e}^{ι 2 π ( c {n}^{2} + c {m}^{2} - \frac{n m}{N} )}$$

increases or decreases with time, the role that cyclic prefix plays for OFDM signals. The cyclic prefix corresponds to a special kind of a chirp periodic prefix with a defined condition (i.e., if 2Nc is an integer) For example, at operation 212, the wireless transmitting device 102 is configured to perform time domain cyclic prefix (CP) insertion at the output of the N-point (c, c) IDAFT of operation 210 when

$$c = \frac{1}{2 N}$$

(so that 2Nc is integer-valued).

In an implementation, the signal obtained from the user by feeding the Mᵤ consecutive entries (e.g., a Mᵤ data symbols) to the Mᵤ precoded input symbols (e.g., Mᵤ contiguous inputs) to form the vector (e.g., a subset [symbol] ᵤ of {0, . . . , N−1}) of the all-zeros N-long vector with the entry ranges assigned to different users u being non-overlapping.

Moreover, the wireless transmitting device 102 is configured to apply the N-point IDAFT to the vector, such as at operation 210. In an example, the N-point IDAFT is also referred as N-point (c₁, c₂) IDAFT, which is based on chirp carriers the phase of each of which is the bivariate polynomial of the precoded input symbol index and the precoded time index, such as the bivariate polynomial includes the first quadratic term of the time index and the second quadratic term of the precoded input symbol index. Furthermore, the first quadratic term of the time index and the second quadratic term of the precoded input symbol index is associated with the same coefficient c, where N≥max{Mu}u∈{1, . . . , U}. In other words, the N-point IDAFT is configured with c₁=c₂=c and is fed with all-zero inputs except for the Mᵤ precoded input symbols (e.g., Mᵤ contiguous inputs) that is generated by Mᵤ-point (c, c)-DAFT-domain precoding of the set of Mᵤ input symbols or data symbols, as shown at operation 206. In an example, if [symbol] ᵤ={0, . . . , Mᵤ−1}, then the wireless transmitting device 102 is configured to generate the discrete affine Fourier transform-spread-affine frequency division multiplexing (DAFT-s-AFDM) signal or waveform as shown below in equation (1).

$${x}_{k}^{D A F T - s - AFDM} = \frac{1}{\sqrt{{M}_{u}}} {\sum }_{n = 0}^{{M}_{u} - 1} ( \frac{1}{\sqrt{{M}_{u}}} {\sum }_{m = 0}^{{M}_{u} - 1} {s}_{m} {e}^{- ι 2 π ( c {m}^{2} + \frac{1}{{M}_{u}} n m + c {n}^{2} )} ) {e}^{ι 2 π ( c {n}^{2} + \frac{1}{N} n k + c {k}^{2} )} \qquad ( 1 )$$

The above equation can be simplified and rewritten as a new equation (2), as shown below.

$${x}_{k}^{D A F T - s - AFDM} = {e}^{ι 2 π c {k}^{2}} {\sum }_{n = 0}^{{M}_{u} - 1} {e}^{- ι 2 π c {n}^{2}} {s}_{n} \frac{1}{{M}_{u}} \frac{1 - {e}^{ι2π \frac{k M u}{N}}}{i - {e}^{- ι2π ( \frac{n}{{M}_{u}} - \frac{k}{N} )}} , \qquad ( 2 )$$

$$= {e}^{ι 2 π c {k}^{2}} {\sum }_{n = 0}^{{M}_{u} - 1} {e}^{- ι 2 π c {n}^{2}} {s}_{n} {g}_{k - P n} , k = 0 , … , N - 1$$

where, N=PMᵤ for some integer P>1 and defined

$${g}_{k} {e}^{ι π ( 1 - \frac{1}{{M}_{u}} ) \frac{k}{P}} \frac{sin π \frac{k}{P}}{{M}_{u} sin \frac{\begin{matrix}π & k\end{matrix}}{\begin{matrix}{M}_{u} & P\end{matrix}}}$$

as the Dirichlet pulse. Moreover, in xₓ^{DAFT-S-AFDM} a transform-domain sample such as sₙ translates into approximately

$$\frac{N}{{M}_{u}} = P$$

contiguous time-domain significant samples due to the decaying profile of the Dirichlet pulse [symbol] ₖ.

Furthermore, the wireless transmitting device 102 is configured to generate the signal with lower peak-to-average power ratio (PAPR) performance as compared to the AFDM signal shown in equation (3).

$${x}_{k}^{A F D M} = \frac{1}{\sqrt{{M}_{u}}} {\sum }_{n = 0}^{{M}_{u} - 1} {s}_{n} {e}^{ι 2 π ( {c}_{2} {n}^{2} + \frac{1}{N} n k + {c}_{1} {k}^{2} )} , k = 0 , … , N - 1. \qquad ( 3 )$$

In other words, the PAPR performance of the DAFT-s-AFDM signal is reduced. Moreover, the DAFT-s-AFDM signal is a single-carrier signal with a chirped Dirichlet pulse shape. Since chirping the pulse only affects the phase of the time-domain samples and not the PAPR performance, therefore the DAFT-s-AFDM signal includes the PAPR performance comparable to that of the signal of the conventional DFT-s-OFDM waveform shown in equation (4).

$${x}_{k}^{D F T - s - O F D M} = {\sum }_{n = 0}^{{M}_{u} - 1} {s}_{n} \frac{1}{{M}_{u}} \frac{1 - {e}^{ι2π \frac{k M u}{N}}}{i - {e}^{- ι2π ( \frac{n}{{M}_{u}} - \frac{k}{N} )}} = {\sum }_{n = 0}^{{M}_{u} - 1} {s}_{n} {g}_{k - {p}_{n}} \qquad ( 4 )$$

where, k=0, . . . , N−1, and N=PMᵤ for some integer P>1 and

$${g}_{k} {e}^{ι π ( 1 - \frac{1}{{M}_{u}} ) \frac{k}{P}} \frac{sin π \frac{k}{P}}{{M}_{u} sin \frac{\begin{matrix}π & k\end{matrix}}{\begin{matrix}{M}_{u} & P\end{matrix}}}$$

is the Dirichlet pulse.

In other words, the PAPR performance of the DAFT-s-AFDM signal is better than that of both the OFDM and the AFDM signals. In an implementation, a number N_{p,u}≥1 of pilot symbols is typically required to be added along with the set of Mᵤ input symbols or data symbols to allow for pilot-based channel estimation at the receiver side, such as at the wireless receiving device 104. In an example, the pilot symbols are embedded with the set of Mᵤ input symbols so that a subset of cardinality N_{p,u} of {sₙ}_{n=0 . . . M}_{ᵤ}₋₁ is composed of the pilot symbols that correspond to transform domain embedded pilot symbols. Thereafter, the wireless transmitting device 102 is configured to transmit the signal on the wireless communication channel 106. In an example, the signal includes transform-domain pilot symbols. In another example, the signal includes a DAFT-domain (i.e., non-embedded) pilot symbols. In addition, DAFT-domain pilots allow to exploit the fact that the DAFT-domain provides an improved delay-Doppler representation of the time-varying channel response as compared to both the time and the frequency domains. In the former domain, channel paths with close delay values but different Doppler shifts and channel paths with close Doppler shift values but different delays appear separated, thus enhancing channel estimation performance. This property of the AFDM and of the DAFT-s-AFDM with DAFT-domain pilots can translate into lower pilot overhead and hence higher spectral efficiency.

In an implementation, the wireless transmitting device 102 provides robust spreading/coverage gain in presence of high-frequency impairments. In such implementation with DAFT-domain (i.e., non-embedded) pilot symbols, the DAFT-s-AFDM signal inherits another AFDM advantage, such as an improved spreading/coverage gain that is robust in presence of carrier frequency offset (CFO) and phase noise (PN). Consider the N-point AFDM or the DAFT-s-AFDM signal transmission from/to a user device u on Mᵤ≤N DAFT chirps. Such a transmission when coupled with the DAFT-domain pilots includes improved robustness of the larger subcarrier spacing 1/Mᵤ of a l(virtual) Mᵤ-point OFDM transmission as opposed to the smaller subcarrier spacing 1/N related to the size N of the underlying transform i.e., the N-point DAFT. Such property is in contrast with both the OFDM and the DFT-s-OFDM for which robustness is determined by the size N of the underlying DFT and not by the number Mᵤ of occupied subcarriers. Moreover, due to the improved robustness, the N-point DAFT-s-AFDM with large values of N can be used on high-frequency channels in power-limited scenarios to provide an N/Mᵤ increase in effective signal-to-interference-plus-noise ratio (SINR) per data symbol (i.e., a N/Mᵤ coverage gain for device u). Moreover, the remaining chirps carriers (e.g., N−Mᵤ) can be used for multiplexing the data symbols from other devices (i.e., without loss in sum spectral efficiency).

In an implementation, the wireless transmitting device 102 is firstly configured to perform digital-to-analog conversion and frequency up-conversion on the signal, such as the DAFT-s-AFDM signal, and then transmit the signal serially on the wireless communication channel 106 to another user, such as to the wireless receiving device 104. In accordance with an embodiment, the wireless transmitting device 102 is further configured to transmit an indication of at least one system parameter with the signal (e.g., the value of N or the DAFT coefficient c), such as with the DAFT-s-AFDM signal. In an implementation, the at least one system parameter can correspond to chirp rate parameter c or N-frame size (i.e., N-size frame). Optionally, the chirp rate corresponds to the rate of change in frequency of the chirp carriers constituting the signal, and the N-frame corresponds to N-long frame defined by the set of Mᵤ input symbols. In an example, the time index n is related to a sampling rate, such as Ts so the duration of the N-long frame cannot exceed N-times of the sampling rate (i.e., NTs) and the frequency of the chirp carriers cannot exceed 1/Ts. Moreover, the indication of at least one system parameter is used for channel estimation and data detection at the receiver side, such as at the wireless receiving device 104.

The wireless transmitting device 102 is configured to transmit the signal, such as the DAFT-s-AFDM signal that is a single-carrier signal with a chirped Dirichlet pulse shape. Beneficially as compared to conventional approaches such as AFDM and OFDM, the DAFT-s-AFDM signal has lower, hence better, PAPR values. When compared to other conventional single-carrier approaches such as DFT-s-OFDM, it provides orthogonality in the DAFT-domain i.e., when DAFT transformation is applied at the receiver side such as at the wireless receiving device 104. In other words, different instances of the wireless transmitting device 102 of the wireless communication system 100A can be used to generate chirped single-carrier signals carrying data from a number of user terminals and occupying the same time and frequency resources (due to the chirping while the signals corresponding to these different users are orthogonally separable at the receiver e.g., base station, side. Also, DAFT-s-AFDM provides orthogonal separability of data and DAFT-domain reference signals and between different DAFT-domain reference signals that might be needed for channel estimation and other possible purposes when transformed into the chirp domain constituted by applying the DAFT transformation. The wireless transmitting device 102 can thus be used for time-varying channel estimation with DAFT-domain pilot symbols such as in AFDM, due to which the DAFT-s-AFDM signal inherits AFDM advantages in terms of enhanced time-varying channel estimation performance and robustness in presence of impairments such as CFO.

FIG. 2B is a diagram that depicts transmission of signals by a wireless transmitting device through a wireless communication channel, in accordance with another embodiment. FIG. 2B is described in conjunction with elements from FIGS. 1A, 1B, and 2A. With reference to FIG. 2B, there is shown a diagram 200B that includes a series of operations from 214-to-226. The wireless transmitting device 102 (of FIG. 1A) is configured to execute the operations shown in the diagram 200B without explicitly using DAFT/IDAFT modules.

The DAFT-s-AFDM signal given by equations (1) and (2) can be seen as a chirped version of the DFT-s-OFDM signal given by equation (4) with chirped input data symbols. Thus, the DAFT-s-AFDM signal can be generated using the following implementation based on a DFT-s-OFDM modulator. At operation 214, the wireless transmitting device 102 is configured to obtain the set of Mu input symbols or the data symbols from the user u. Thereafter, at operation 216, the wireless transmitting device 102 is configured to perform transform-domain pilot insertion, such as among the non-pilot input symbols. Moreover, at operation 218, the wireless transmitting device 102 is configured to perform chirping on the input symbols {sₘ}_{m=0 . . . M}_{ᵤ}₋₁ e.g., by using the complex exponentials {μₘ^{*}}_{m∈} [symbol] _{ᵤ} with μₘ [symbol] e^{i2πcm}^{²}, m=mᵤ, . . . , mᵤ+Mᵤ−1, and mᵤ corresponds to the smallest index of the precoded input symbol index in the [symbol] ᵤ set to obtain the set of Mu chirped input symbols {sₘμₘ^{*}}_{n=0 . . . M}_{ᵤ}₋₁. Thereafter, the wireless transmitting device 102 is configured to place the Mu chirped input symbols on the Mu consecutive entries of an all-zeros N-long vector with the entry ranges assigned to different users u being non-overlapping. Moreover, at operation 220, the wireless transmitting device 102 is configured to feed the Mu chirped input symbols to the inputs corresponding to index set [symbol] ᵤ of a N-point DFT-s-OFDM to get a N-long vector. In addition, at operation 222, the wireless transmitting device 102 is configured to apply chirping (e.g., γn-chirping) on the N-long vector, due to which the DAFT-S-AFDM signal (i.e., xₖ^{DAFT-s-AFDM})_{k=0 . . . N-1} is a time-domain chirping (e.g., by using the complex exponentials {γₙ^{*}}_{n=0,1, . . . ,N-1} with γₖ [symbol] e^{i2πck}^{²}, k=0, . . . N−1) of a DFT-s-OFDM signal xₖ^{DFT-s-OFDM} of equation (4).

Optionally, at operation 224, the wireless transmitting device 102 is configured to perform DAFT-domain pilot insertion, such as by adding chirps in the time domain, such as

$${p}_{n}^{td} \frac{1}{\sqrt{N}} {\sum }_{m ∈ {R}_{u}} {p}_{m}^{daft} {e}^{i 2 π} ( c {m}^{2} + \frac{1}{N} m ( n ) + {c ( n )}^{2} )$$

where pₘ^{daft} is the value of the DAFT-domain pilot symbol at DAFT index m∈Rᵤ. Moreover, at operation 226, the wireless transmitting device 102 is configured to perform time domain cyclic prefix (CP) insertion at the DAFT-s-AFDM signal. Thus, the DAFT-s-AFDM signal or waveform can be seen as a chirped a DFT-s-OFDM signal with chirped input data symbols. In other words, the DAFT-s-AFDM signal can be generated without IDAFT/DAFT modules, which is further transmitted to the wireless communication channel 106. In an implementation, the DAFT-s-AFDM signal of the wireless transmitting device 102 (i.e., transceiver) includes back compatibility with legacy wireless systems, such as with the wireless communication system 100A. In an example, due to the absence of an IDAFT module, the wireless transmitting device 102 does not have a direct access to the DAFT domain. Thus, if transmitting DAFT-domain (i.e., non-embedded) pilot symbols insertion is required, then it may be performed by adding the time-domain samples to the time-domain samples of the data part of the DAFT-s-AFDM signal.

In an implementation, for each terminal u∈{1, . . . , U}, the wireless transmitting device 102 is configured to arrange the signal (e.g., data) and any possible pilot symbols that might be embedded with them into frames. Moreover, each frame includes the set of Mᵤ input symbols and multiplying the samples with a complex exponentials {μₘ^{*}}_{m∈} [symbol] _{ᵤ} where μₘ=e^{i2πcm}^{²} before feeding them to the inputs defined by the indexes in [symbol] ᵤ of a N-point DFT-s-OFDM modulator. Thereafter, the wireless transmitting device 102 is configured may be configured to add to the individual N-long chirps, each corresponding to one non-embedded DAFT-domain pilot symbol with chirp parameters determined by a particular index from [symbol] that the pilot symbol occupies. Furthermore, supplementing the set of Mᵤ input symbols at the output of the N-point DFT-s-OFDM modulator with a cyclic prefix (CP) and multiplying the N+L samples at the output of this modulator with the complex exponentials

$${\{ {γ}_{n}^{*} \}}_{n = - L , … , - 1 , 0 , 1 , … , N - 1} where {γ}_{n} = {e}^{ι 2 π c {n}^{2}} .$$

FIG. 3A is a diagram that depicts transform-domain (embedded) pilot symbols and guard samples, in accordance with an embodiment. FIG. 3A is described in conjunction with elements from FIGS. 1A to 2B. With reference to FIG. 3A, there is shown a diagram 300A that depicts transform-domain pilot symbols and guard samples represented both in the transform (i.e., the input to the point precoder, domain and in the time domain). There is further shown a set of Mᵤ precoded input symbols 302 that include both transform-domain pilots and guard samples and non-pilot symbols, and a discrete affine Fourier transform spread affine frequency division multiplexing (DAFT-s-AFDM) signal 304 in the time domain with the range occupied by the time-domain samples corresponding to the transform-domain pilots and guards.

With reference to FIG. 3A, there is shown that the guard samples are inserted between different transform domain pilot symbols to form the set of My input symbols. In an implementation, the guard samples are inserted between different embedded pilot symbols and between embedded pilot symbols and the non-pilot input symbols. In an example, the first processor 108 is used by the wireless transmitting device 102 to insert the guard samples between different embedded pilot symbols and also between the embedded pilot symbols and the non-pilot input symbols. The guard samples are used to separate each pilot symbol from other pilot symbols, such as to separate different transform domain pilot symbols. As a result, the guard samples are used to prevent interference between two different transform domain pilot symbols. In such embodiments, the guard samples have non-zero values, and the guard samples may also be referred to as non-zero guard samples. Therefore, the guard samples may also be referred to as constant-amplitude samples that are shown away from zero-samples.

There is further shown a representation of the DAFT-s-AFDM signal 304 in the time-domain. In addition, the guard samples may occupy an interval in the time domain of the DAFT-s-AFDM signal 304 and may provide low peak-to-average power ratio (PAPR) performance, as shown in FIG. 3A. In an implementation, the wireless transmitting device 102 is configured to append the DAFT-s-AFDM signal 304 (or transmitted signal) with a chirp periodic prefix or a cyclic prefix after applying the N-point IDAFT to generate the DAFT-s-AFDM signal 304 from the vector formed by placing Mu precoded input symbols on Mu consecutive entries of an all-zeros N-long vector with the entries ranges assigned to different users u being non-overlapping. Therefore, the DAFT-s-AFDM signal 304 includes a time domain cyclic prefix (CP), as shown in FIG. 3A.

FIG. 3B is a diagram that depicts DAFT-domain (non-embedded) pilot symbols and guard samples, in accordance with an embodiment. FIG. 3B is described in conjunction with elements from FIGS. 1A to 2B. With reference to FIG. 3B, there is shown a diagram 300B that depicts DAFT-domain pilot symbols and guard samples. There is a further shown a set of Mu precoded input symbols 306, and a discrete affine Fourier transform spread affine frequency division multiplexing (DAFT-s-AFDM) signal 308.

In accordance with an embodiment, the wireless transmitting device 102 is configured to append the transmitted signal with a set of Ru DAFT-domain pilot symbols by placing the Ru pilot symbols on Ru consecutive entries of the vector at the input of the N-point IDAFT that are non-overlapping with the entries occupied by the outputs of the Mu-point DAFT. In such embodiment, the wireless transmitting device 102 is further configured to insert the guard samples between predefined symbols to form the set of Ru appended DAFT-domain pilot symbols and in the vector at the input of the N-point IDAFT between the set of Mu precoded input symbols 306 and the set of Ru appended DAFT-domain pilot symbols, as shown in FIG. 3B. In an implementation, one or more inputs of the N-point IDAFT (i.e., IDAFT module) are forming the set of [symbol] ᵤ⊂{0, . . . , N−1} that can be dedicated to transmitting a number N_{p,u}< [symbol] ᵤ| of pilot symbols. In an example, the difference in the modulus of the subset [symbol] ᵤ, and the number N_{p,u} (i.e., | [symbol] ᵤ|−N_{p,u}) is the number of the guard samples that are required for channel estimation at the receiver side, such as at the wireless receiving device 104. As a result, such pilot symbols are referred to as “non-embedded” since they are not embedded with the data symbols in the transform domain and also as “DAFT-domain” since such pilot symbols are directly fed to the N-point IDAFT (i.e., IDAFT module). In such embodiments, the wireless transmitting device 102 is further configured to append the transmitted signal, such as the DAFT-s-AFDM signal 308 with a chirp periodic prefix or a cyclic prefix after applying the N-point IDAFT to generate the signal. Moreover, the time-domain samples of the DAFT-s-AFDM signal 308 correspond to the sum of a chirped single-carrier signal (i.e., the data part of the DAFT-S-AFDM signal 308) and of one or more chirp signals, and each corresponding to one DAFT-domain pilot symbol. As a result, the time-domain samples of the DAFT-domain pilot symbols are shown in FIG. 3B to occupy the whole time range of signal 308.

FIG. 4 is a diagram that depicts a flowchart of a method for transmitting a signal on a wireless communication channel, in accordance with an embodiment. FIG. 4 is described in conjunction with elements from FIGS. 1A to 3B. With reference to FIG. 4, there is shown a flowchart of a method 400 for transmitting a signal on the wireless communication channel 106 (of FIG. 1A). The method 400 includes steps 402-to-408. Moreover, the wireless transmitting device 102 (of FIG. 1A) is configured to execute the method 400.

The method 400 is used for transmitting the signal on the wireless communication channel 106. The signal corresponds to a discrete affine Fourier transform (DAFT)-spread-affine frequency division multiplexing (AFDM) signal with low-peak to average power ratio (PAPR) performance for wireless transmission with improved affine frequency division multiplexing waveforms for doubly dispersive channels.

At step 402, the method 400 comprises, obtaining a set of Mu input symbols from a user, where u∈{1, . . . , U} and U≥1. The wireless transmitting device 102 (of FIG. 1A) is configured to obtain the set of Mu input symbols from the user. In accordance with an embodiment, for obtaining at least one set of Mu input symbols, the method 400 comprises, obtaining input symbols from one user device and embedding transform-domain pilot symbols within these input symbols, to form the corresponding set of Mu input symbols. The wireless transmitting device 102 is configured to obtain the set of Mu input symbols (e.g., non-pilot input symbols) from one user device and then embed the transform-domain pilot symbols within the received input symbols to form the corresponding set of Mu input symbols. Therefore, the set of Mu input symbols includes different embedded transform-domain pilot symbols and the received input symbols. In accordance with an embodiment, the method 400 further comprises inserting a guard sample between two symbols into the corresponding set of Mu input symbols. For example. The wireless transmitting device 102 is further configured to insert the guard sample between the transform-domain pilot symbols and the received input symbols into the corresponding set of Mu input symbols. The guard samples are used to separate each symbol from other symbols, such as to separate different embedded pilot symbols from each other. In such embodiments, the guard sample comprises non-zero values. Therefore, the guard samples may also be referred to as constant-amplitude samples that may occupy an interval in the time domain and provide low peak-to-average power ratio (PAPR) performance.

At step 404, the method 400 comprises, applying a precoder for each of the set of Mu input symbols to generate U sets of precoded input symbols, and the precoder includes an Mu-point discrete affine Fourier transform (DAFT), based on chirp carriers the phase of each of which is a bivariate polynomial of input symbol index and the time index. Moreover, the bivariate polynomial includes a first quadratic term of the time index and a second quadratic term of the input symbol index. The first quadratic term of the time index and second quadratic term of the time index are associated with a same coefficient c based on a system parameter. The wireless transmitting device 102 (of FIG. 1A) is configured to apply the Mᵤ-point DAFT on the set of Mu input symbols to generate a set of precoded input symbols based on the bivariate polynomial of the input symbol index m and the time index n. In an example. the first quadratic term of the time index n is associated with a coefficient c1, and the second quadratic term of the input symbol index m is associated with a coefficient c2, and c1=c2=c.

In accordance with an embodiment, the method 400 further comprises appending the transmitted signal with a set of Ru DAFT-domain pilot symbols by placing the Ru pilot symbols on Ru consecutive entries of the vector at the input of the N-point IDAFT that are non-overlapping with the entries occupied by the outputs of the Mu-point DAFT. The wireless transmitting device 102 (of FIG. 1A) is configured to append the transmitted signal with the set of Ru DAFT-domain pilot symbols (i.e., perform DAFT-domain pilot insertion) by placing the Ru pilot symbols on the Ru consecutive entries of the vector at the input of the N-point IDAFT that are non-overlapping with the entries occupied by the outputs of the Mu-point DAFT (i.e., Mu-point (c, c) DAFT). In such embodiment, the method 400 further comprises, inserting guard samples between predefined symbols to form the set of Ru appended DAFT-domain pilot symbols and in the vector at the input of the N-point IDAFT between the set of Mu precoded input symbols and the set of Ru appended DAFT-domain pilot symbols. The wireless transmitting device 102 (of FIG. 1A) is configured to insert the guard samples between predefined symbols. In an example, such pilot symbols may be referred to as “non-embedded” since they are not embedded with the data symbols in the transform domain and also as “DAFT-domain” since such pilot symbols are directly fed to the N-point IDAFT (i.e., IDAFT module).

At step 406, the method 400 further comprises, applying an N-point inverse discrete affine Fourier transform (IDAFT), to a vector formed by placing the Mᵤ precoded input symbols on Mᵤ consecutive entries of an all-zeros N-long vector with the entries ranges assigned to different users u being non-overlapping to generate the signal. The N-point IDAFT is based on chirp carriers the phase of each of which is a bivariate polynomial of precoded input symbol index and the time index. Moreover. The bivariate polynomial includes a first quadratic term of the time index and a second quadratic term of the precoded input symbol index. The first quadratic term of the time index and the second quadratic term of the precoded input symbol index is associated with the same coefficient c, where N≥max {Mᵤ}_{u∈{1, . . . , U}}. Firstly, the wireless transmitting device 102 is configured to place the Mᵤ precoded input symbols on the Mᵤ consecutive entries of an all-zeros N-long vector with the entry ranges assigned to different users u being non-overlapping to form the vector. Thereafter, the wireless transmitting device 102 is further configured to apply the N-point IDAFT to the vector. In accordance with an embodiment, the method 400 further comprises, appending a prefix to the transmitted signal after applying the N-point IDAFT to generate the signal. The wireless transmitting device 102 (of FIG. 1A) is configured to perform time domain cyclic prefix (CP) insertion at the output of the N-point IDAFT. In an implementation, the prefix is a chirp periodic corresponds to a chirp carrier in which frequency increases or decreases with time. The chirp period prefix is simply a cyclic prefix under defined conditions (i.e., if 2Nc is an integer).

In an implementation, if [symbol] ᵤ={0, . . . , Mᵤ−1}, then the wireless transmitting device 102 is configured to generate the discrete affine Fourier transform-spread-affine frequency division multiplexing (DAFT-s-AFDM) signal or waveform of equation (1). Furthermore, the wireless transmitting device 102 is configured to generate the signal with lower peak-to-average power ratio (PAPR) performance as compared to the AFDM signal. In other words, the PAPR performance of the DAFT-s-AFDM signal is lower. Moreover, the DAFT-s-AFDM signal is a single-carrier signal with a chirped Dirichlet pulse shape. Since chirping the pulse only affects the phase of the time-domain samples and not the PAPR, therefore the DAFT-s-AFDM signal includes the PAPR performance comparable to that of the DFT-s-OFDM. In other words, the PAPR performance of the DAFT-s-AFDM signal is lower than that of both the OFDM and the AFDM signals. In an implementation, a number N_{p,u}≥1 of pilot symbols is typically required to be added along with the data symbols to allow for pilot-based channel estimation at the receiver side, such as at the wireless receiving device 104. In an example, the pilots symbols are embedded with the set of Mᵤ input symbols so that a subset of cardinality N_{p,u} of {sₙ}_{n=0 . . . M}_{ᵤ}₋₁ is composed of the pilot symbols that correspond to transform domain embedded pilot symbols.

At step 408, the method 400 comprises, transmitting the signal on the wireless transmitting device 102. In an implementation, the wireless communication channel 106 is firstly configured to perform digital-to-analog conversion and frequency up-conversion on the signal, such as the DAFT-s-AFDM signal, and then transmit the signal serially on the wireless communication channel 106 to another user, such as to the wireless receiving device 104. In accordance with an embodiment, the method 400 further comprises, transmitting an indication of at least one system parameter with the signal, such as with the DAFT-s-AFDM signal. In an implementation, the at least one system parameter can correspond to chirp rate parameter c or N-frame size. In an example, the chirp rate corresponds to the rate of change in frequency of the signal, and the N-frame corresponds to N-long frame defined by the set of Mᵤ input symbols. Moreover, the indication of at least one system parameter is used for channel estimation and data detection at the receiver side, such as at the wireless receiving device 104. The method 400 achieves all the advantages and technical effects of the wireless transmitting device 102 of the wireless communication system 100A.

The steps 402 to 408 are only illustrative, and other alternatives can also be provided where one or more steps are added, one or more steps are removed, or one or more steps are provided in a different sequence without departing from the scope of the claims herein.

FIG. 5A is a diagram that depicts a wireless receiving device to receive a signal from a wireless communication channel, in accordance with an embodiment. FIG. 5A is described in conjunction with elements from FIGS. 1A and 3B. With reference to FIG. 5A, there is shown a diagram 500A that includes a series of operations from 502-to-530. The wireless receiving device 104 (of FIG. 1A) is configured to execute the operations shown in the diagram 500A.

In operation, the wireless receiving device 104 is configured to receive a signal from the wireless communication channel 106 (of FIG. 1A). The wireless receiving device 104 is configured to receive the signal from U user devices, {1, . . . , U} and U≥1, and the user device {1, . . . , U} corresponds to the wireless transmitting device 102. Firstly, the user device, such as the wireless transmitting device 102 is configured to transmit the signal (e.g., a discrete affine Fourier transform spread affine frequency division multiplexing (DAFT-s-AFDM)) signal, and then the wireless receiving device 104 is configured to receive the signal from the wireless communication channel 106. In an example, the wireless receiving device 104 can simultaneously receive one or more signals from one or more user devices.

In accordance with an embodiment, the wireless receiving device 104 is configured to receive an indication of at least one system parameter with the signal. In an implementation, at least one system parameter can correspond to chirp rate parameter c or N-frame size. In an example, the chirp rate corresponds to the rate of change in frequency of the signal, and the N-frame corresponds to the N-long frame defined by the signal. Moreover, the indication of at least one system parameter is used by the wireless receiving device 104 for the estimation of the wireless communication channel 106 and for data detection.

In accordance with an embodiment, the wireless receiving device 104 is further configured to remove a chirp periodic prefix or a cyclic prefix (CP) from the received signal. For example, at operation 502, the wireless receiving device 104 is configured to perform time domain CP removal to remove a chirp periodic prefix or a cyclic prefix (CP) from the received signal. Optionally, if the signal received from the user device, such as received from the wireless transmitting device 102 includes transform-domain (embedded) pilot symbols, then the time-domain samples of the received signal corresponding to the transform-domain pilot symbols can be used by the wireless receiving device 104 for channel estimation. For example, at operation 504, the wireless receiving device 104 is configured to perform time-domain channel estimation on the N received symbols (i.e., N number of symbols).

The wireless receiving device 104 is configured to apply an N-point discrete affine Fourier transform (DAFT), to the N received symbols to generate U sets, each comprising Mu DAFT-domain symbols, For example, at operation 506, the wireless receiving device 104 is configured to apply the N-point DAFT on the N received symbols, and the N-point DAFT is based on chirp carriers the phase of each of which is the bivariate polynomial of symbol index and the time index. In an example, a vector of N DAFT-domain samples containing the composite contribution of the U sets of Mu transmitted symbols. In an implementation, the wireless receiving device 104 is configured to apply the N-point DAFT (i.e., N-point (c, c)-DAFT) to a vector of samples resulting from down-converting the received signal (e.g., radio signal), sampling the signal, and removing (i.e., discarding) the cyclic prefix from the signal. In addition, the bivariate polynomial includes a first quadratic term of the time index and a second quadratic term of the symbol index. Moreover, the first quadratic term of the time index and the second quadratic term of the symbol index are associated with the same coefficient c based on a system parameter, and where N≥max {Mu}u∈{1, . . . , U}. Moreover, the wireless receiving device 104 is configured to estimate the time-domain signal based on the time-domain samples and then transform the result to the DAFT-domain where it is needed for equalization. For example, at operation 508, operation 510, and at operation 512, the wireless receiving device 104 is configured to perform equalization. Alternatively, if DAFT-domain (non-embedded) pilot symbols were received by the wireless receiving device 104, then channel estimation can be performed directly in the DAFT-domain estimation (or DAFT-domain pilot estimation). For example, at operation 514, at operation 516, and at operation 518, the wireless receiving device 104 is configured to perform the DAFT-domain estimation based on the received DAFT-domain pilot samples.

In accordance with an embodiment, the signal generated by the wireless receiving device 104 at the output of the N-point DAFT includes Mu DAFT-domain received samples related to the Mu transmitted precoded symbols and Ru DAFT-domain received pilot symbols whose indexes define a set [symbol] ᵤ that is a subset of {0, . . . , N−1}. In an implementation, if the set [symbol] ᵤ of DAFT-domain pilot symbols indexes is empty, then estimating the wireless communication channel 106 of the user device (i.e., user device u) is based on the time-domain samples corresponding to the pilot symbols embedded with the data symbols, such as the Mu DAFT-domain transmitted symbols, In another implementation, if the set [symbol] ᵤ is not empty, then estimating the wireless communication channel 106 is based on the DAFT-domain samples received on indexes defined by the set [symbol] ᵤ within the N-frame resulting from the N-point DAFT. Moreover, the wireless receiving device 104 is further configured to equalize a corresponding set of Mu DAFT-domain received symbols using the thus obtained channel estimate.

The wireless receiving device 104 is further configured to apply an inverse precoder for each of the U set that include DAFT-domain precoded symbols to generate U sets of estimated input symbols. Moreover, the inverse precoder includes an Mᵤ-point inverse discrete affine Fourier transform (IDAFT). For example, at operation 520, at operation 522, and at operation 524, the wireless receiving device 104 is configured to apply the Mᵤ-point IDAFT (i.e., Mᵤ-point (c, c) IDAFT) for each of the U sets including DAFT-domain symbols to generate the set of estimated input symbols, based on a bivariate polynomial of DAFT-domain symbol index and the time index. Moreover, the bivariate polynomial includes a first quadratic term of the time index and a second quadratic term of the DAFT-domain symbol index. Further, the first quadratic term of the time index and the second quadratic term of the DAFT-domain symbol index is associated with the same coefficient c. Moreover, the wireless receiving device 104 is configured to equalize the wireless communication channel 106 that affects the remaining samples for example by using linear minimum mean squared error (LMMSE) equalization and estimate (e.g., at operation 526, at operation 528, and at operation 530) the received data symbols of the user device (e.g., u) by applying Mᵤ-point (c, c)-IDAFT to the output of the above equalization steps with the same coefficient c.

The wireless receiving device 104 is configured to receive the signal, such as a discrete affine Fourier transform-spread-affine frequency division multiplexing (DAFT-s-AFDM) signal that is a single-carrier signal with a chirped Dirichlet pulse shape. Beneficially as compared to conventional approaches, the DAFT-s-AFDM signal along with the chirp periodic prefix (i.e., chirp pilot) are orthogonal in the DAFT-domain that provide an improved PAPR performance. As a result, the DAFT-s-AFDM signal is separable from data when the DAFT transformation is applied by the wireless receiving device 104.

FIG. 5B is a diagram that depicts a wireless receiving device to receive a signal from a wireless communication channel, in accordance with another embodiment. FIG. 5B is described in conjunction with elements from FIGS. 1A and 5A. With reference to FIG. 5B, there is shown a diagram 500B that includes a series of operations from 502, 532-to-556. The wireless receiving device 104 (of FIG. 1A) is configured to execute the operations shown in the diagram 500B without explicitly using DAFT/IDAFT modules.

Firstly, the wireless receiving device 104 is configured to receive the signal from the wireless communication channel 106. In an example, the wireless receiving device 104 does not have direct access to the DAFT-domain due to the absence of a DAFT module. Thereafter, at operation 524, the wireless receiving device 104 is configured to perform γn-chirping on the output of the time domain CP removal module and then subtract the samples that correspond to the data-only part of the received signal from the output of the time domain CP removal module. After that, the wireless receiving device 104 is configured to perform the operation 536 which corresponds to a DFT-s-OFDM receiver, which further includes a series of operations. For example, at operation 538, the wireless receiving device 104 is configured to execute a N-point FFT module to subtract the frequency domain samples {rₘ}_{m=0 . . . N-1} The wireless receiving device 104 is further configured to perform frequency domain equalization, for example at operation 540, at operation 542, and at operation 544. Thereafter, at operation 546, at operation 548, and at operation 550, the wireless receiving device 104 is configured to perform Mu-point inverse fast Fourier transform (IFFT) on the received signals. Finally, data symbol estimation is performed, such as shown by operation 552, operation 554, and operation 556. In an example, the data symbol estimation is performed by applying Mᵤ-point IFFT to the output of the above equalization operations, such as the operation 540, the operation 542, and the operation 544.

In an implementation, if the DAFT-domain (i.e., non-embedded) pilot symbols were transmitted by user u (i.e., in the case where [symbol] ᵤ is not empty), then the wireless receiving device 104 is configured to estimate the DAFT-domain channel response. Without DAFT modules, this is done for example based on the time-domain samples obtained by subtracting from the output of the CP removal module the time-domain samples corresponding to the data-only part of the received signal. For example, at operation 502, the wireless receiving device 104 is configured to perform time domain CP removal on the received signals, such as by using a time domain CP removal module. Optionally, at operation 532, the wireless receiving device 104 may be configured to perform channel estimation based on the time domain pilot samples, as shown below in equation (5).

$${\{ {Y}_{n} - {e}^{- ι 2 π c {n}^{2}} {\sum }_{u = 1}^{U} {\sum }_{m ∈ {ℳ}_{u}} {r}_{m} {e}^{ι 2 π \frac{m n}{N}} \}}_{n = 0 … N - 1} \qquad ( 5 )$$

FIG. 6 is a diagram that depicts a flowchart of a method for receiving a signal on a wireless communication channel, in accordance with an embodiment. FIG. 6 is described in conjunction with elements from FIGS. 1A to 5B. With reference to FIG. 6, there is shown a flowchart of a method 600 for receiving a signal from the wireless communication channel 106 (of FIG. 1A). The method 600 includes steps 602-to-606. Moreover, the wireless receiving device 104 (of FIG. 1A) is configured to execute the method 600.

The method 600 is used for receiving the signal on the wireless communication channel 106. The signal corresponds to a discrete affine Fourier transform (DAFT)-spread-affine frequency division multiplexing (AFDM) signal with low-peak to average power ratio (PAPR) performance for wireless transmission with improved affine frequency division multiplexing waveforms for doubly dispersive channels.

At step 602, the method 600 comprises receiving the signal, wherein the signal comprises contribution from U sets of Mᵤ transmitted symbols from U users, where u∈{1, . . . , U} and U≥1. The wireless receiving device 104 is configured to receive the signal from U user devices, such as from the wireless transmitting device 102. In accordance with an embodiment, the method 600 further comprises receiving an indication of at least one of the system parameters with the signal. In an implementation, at least one system parameter can correspond to chirp rate or N-frame size. In accordance with an embodiment, the method 600 further comprises removing a chirp periodic prefix or a cyclic prefix (CP) from the received signal to generate the U sets comprising Mᵤ DAFT-domain symbols. The wireless receiving device 104 is configured to perform time domain CP removal to remove a chirp periodic prefix or a cyclic prefix (CP) from the received signal.

At step 604, the method 600 comprises applying an N-point discrete affine Fourier transform (DAFT), to the N received samples after prefix removal to generate a vector of N DAFT-domain samples containing the composite contribution of the U sets of Mᵤ transmitted symbols. The N-point DAFT is based on a bivariate polynomial of symbol index and time index, the bivariate polynomial comprising a first quadratic term of the time index and a second quadratic term of the symbol index. In addition, the first quadratic term of the time index and the second quadratic term of the symbol index is associated with the same coefficient c based on a system parameter and a channel parameter. In an example, the number N of received symbols is larger than Mᵤ. Moreover, the wireless receiving device 104 is configured to estimate the time-domain signal based on the time-domain samples and then transform the result to the DAFT-domain for equalization.

In accordance with an embodiment, the method 600 further comprises at least one of the U sets comprising Mᵤ DAFT-domain symbols includes N_{p,u} transform-domain (embedded) pilots symbols. The method 600 further comprises equalizing the corresponding Mᵤ DAFT-domain symbols based on chirp carriers the phase of each of which is a channel estimated obtained using the N_{p,u} transform-domain pilots symbols prior to applying the inverse precoder. The wireless receiving device 104 is configured to equalize, prior to applying the inverse precoder, the corresponding Mᵤ DAFT-domain received symbols based on a channel estimate obtained using the Rᵤ DAFT-domain pilot symbols. In such embodiment, the signal includes, for at least one set of Mᵤ received symbols, a set of Rᵤ DAFT-domain pilot symbols.

At step 606, the method 600 comprises, applying an inverse precoder for each of the sets comprising DAFT-domain symbols to generate U sets of estimated symbols, the inverse precoder comprising a Mᵤ-point inverse discrete affine Fourier transform (IDAFT), based on chirp carriers the phase of each of which is a bivariate polynomial of DAFT-domain symbol index and the time index. The wireless receiving device 104 is configured to apply the Mᵤ-point IDAFT (i.e., Mᵤ-point (c, c) IDAFT) for each of the set including DAFT-domain symbols to generate the set of estimated input symbols, based on a bivariate polynomial of DAFT-domain symbol index and the time index. Moreover, the bivariate polynomial includes a first quadratic term of the time index and a second quadratic term of the DAFT-domain symbol index, the first quadratic term of the time index, and the second quadratic term of the DAFT-domain symbol index being associated with the same coefficient c. Moreover, the wireless receiving device 104 is configured to first equalize the wireless communication channel 106 that affects the remaining samples and estimate the received data symbols of the user device (e.g., u) by applying Mᵤ-point (c, c)-IDAFT to the output of the above equalization steps with the same coefficient c. The method 600 achieves all the advantages and technical effects of a wireless receiving device 104 of the wireless communication system 100A.

The steps 602 to 606 are only illustrative, and other alternatives can also be provided where one or more steps are added, one or more steps are removed, or one or more steps are provided in a different sequence without departing from the scope of the claims herein.

There is provided a computer program product comprising program instructions for performing the method 400 and/or the method 600, when executed by one or more processors in a computer system. The computer program product is implemented as an algorithm, embedded in a software stored in the non-transitory computer-readable storage medium having program instructions stored thereon, the program instructions being executable by the one or more processors in the computer system to execute the method 400 and/or the method 600. The non-transitory computer-readable storage means may include, but are not limited to, an electronic storage device, a magnetic storage device, an optical storage device, an electromagnetic storage device, a semiconductor storage device, or any suitable combination of the foregoing. Examples of implementation of computer-readable storage medium, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer-readable storage medium, and/or CPU cache memory.

There is further provided a computer system comprising one or more processors and one or more memories, the one or more memories storing program instructions which, when executed by the one or more processors, cause the one or more processors to execute the method 400 and/or the method 600. The computer system is implemented as an algorithm, embedded in a software stored in the non-transitory computer-readable storage medium having program instructions stored thereon, the program instructions being executable by the one or more processors in the computer system to execute the method 400 and/or the method 600. The non-transitory computer-readable storage means may include, but are not limited to, an electronic storage device, a magnetic storage device, an optical storage device, an electromagnetic storage device, a semiconductor storage device, or any suitable combination of the foregoing. Examples of implementation of computer-readable storage medium, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer-readable storage medium, and/or CPU cache memory.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

What is claimed is:

1. A wireless transmitting device configured to transmit a signal on a wireless communication channel, the wireless transmitting device being configured to:
obtain a set of Mᵤ input symbols from a user u, where u∈{1, . . . , U} and U≥1;
apply a precoder for the set of Mᵤ input symbols to generate a set of Mᵤ precoded input symbols, the precoder comprising an Mᵤ-point discrete affine Fourier transform (DAFT), based on chirp carriers the phase of each of which is a bivariate polynomial of input symbol index m and time index n, the bivariate polynomial comprising a first quadratic term of the time index and a second quadratic term of the input symbol index, the first quadratic term of the time index and the second quadratic term of the input symbol index being associated with a same coefficient c based on a system parameter;
apply an N-point inverse discrete affine Fourier transform (IDAFT), to a vector formed by placing the Mᵤ precoded input symbols on Mᵤ consecutive entries of an all-zeros N-long vector with the entries ranges assigned to different users u being non-overlapping, the N-point IDAFT being based on chirp carriers the phase of each of which is a bivariate polynomial of precoded input symbol index and time index, the bivariate polynomial comprising a first quadratic term of the time index and a second quadratic term of the precoded input symbol index, the first quadratic term of the time index and the second quadratic term of the precoded input symbol index being associated with the same coefficient c, where N≥max{Mᵤ}_{u∈{1, . . . , U}}; and
transmit the signal on the wireless communication channel.

2. The device according to claim 1, further configured to transmit an indication of at least one system parameter with the signal.

3. The device according to claim 1, further configured to form the set of Mᵤ input symbols by embedding transform-domain pilot symbols among non-pilot input symbols.

4. The device according to claim 3, further configured to form the set of Mᵤ input symbols by inserting guard samples between different embedded pilot symbols and between embedded pilot symbols and non-pilot input symbols.

5. The device according to claim 4, wherein the guard samples have non-zero values.

6. The device according to claim 1 further configured to append the transmitted signal with a set of Rᵤ DAFT-domain pilot symbols by placing the Rᵤ pilot symbols on Rᵤ consecutive entries of the vector at the input of the N-point IDAFT that are non-overlapping with the entries occupied by the outputs of the Mᵤ-point DAFT.

7. The device according to claim 6, further configured to insert guard samples between predefined symbols to form the set of Rᵤ appended DAFT-domain pilot symbols and in the vector at the input of the N-point IDAFT between the set of Mᵤ precoded input symbols and the set of Rᵤ appended DAFT-domain pilot symbols.

8. A method for transmitting a signal on a wireless communication channel, the method comprising:
obtaining a set of Mᵤ input symbols from a user u, where u∈{1, . . . , U} and U≥1;
applying a precoder for each of the set of Mᵤ input symbols to generate a set of Mᵤ precoded input symbols, the precoder comprising an Mᵤ-point discrete affine Fourier transform (DAFT), based on chirp carriers the phase of each of which is a bivariate polynomial of input symbol index and time index the bivariate polynomial comprising a first quadratic term of the time index and a second quadratic term of the input symbol index, the first quadratic term of the time index and second quadratic term of the input symbol index being associated with a same coefficient c based on a system parameter and a channel parameter;
applying an N-point inverse discrete affine Fourier transform (IDAFT), to to a vector formed by placing the Mᵤ precoded input symbols on Mᵤ consecutive entries of an all-zeros N-long vector with the entries ranges assigned to different users u being non-overlapping to generate the signal, the N-point IDAFT being based on chirp carriers the phase of each of which is a bivariate polynomial of precoded input symbol index and time index, the bivariate polynomial comprising a first quadratic term of the time index and a second quadratic term of the precoded input symbol index, the first quadratic term of the time index and the second quadratic term of the precoded input symbol index being associated with the same coefficient c, where N≥max{Mᵤ}_{u∈{1, . . . , U}}; and
transmitting the signal on the wireless communication channel.

9. The method according to claim 8, further comprising transmitting an indication of at least one system parameter with the signal.

10. The method according to claim 8, further comprising, for obtaining at least one set of Mᵤ input symbols, receiving input symbols from one user devices and embedding transform-domain pilot symbols within the received input symbols, to form the corresponding set of Mᵤ input symbols.

11. The method according to claim 10, further comprising inserting a guard sample between two symbols into the corresponding set of Mᵤ input symbols.

12. The method according to claim 11, wherein the guard sample comprises non-zero values.

13. The method according to claim 8, further comprising appending the transmitted signal with a set of Rᵤ DAFT-domain pilot symbols by placing the Rᵤ pilot symbols on Rᵤ consecutive entries of the vector at the input of the N-point IDAFT that are non-overlapping with the entries occupied by the outputs of the Mᵤ-point DAFT.

14. The method according to claim 13, further comprising inserting a guard samples between predefined symbols to form the set of Rᵤ appended DAFT-domain pilot symbols and in the vector at the input of the N-point IDAFT between the set of Mᵤ precoded input symbols and the set of Rᵤ appended DAFT-domain pilot symbols.

15. The method according to claim 8 further comprising appending a periodic prefix to the transmitted signal after applying the N-point IDAFT to generate the signal.

16. A method for receiving a signal from a wireless communication channel (106), the method (600) comprising:
receiving the signal, wherein the signal comprises U sets of Mᵤ received symbols for a user, where u∈{1, . . . , U} and U≥1;
applying an N-point discrete affine Fourier transform (DAFT), to an aggregation of the U sets of Mᵤ received symbols, to generate U sets each comprising Mᵤ DAFT-domain symbols, the N-point DAFT being based on chirp carriers the phase of each of which is a bivariate polynomial of symbol index and time index, the bivariate polynomial comprising a first quadratic term of the time index and a second quadratic term of the symbol index, the first quadratic term of the time index and the second quadratic term of the symbol index being associated with a same coefficient c based on a system parameter and a channel parameter, and where N≥max{Mᵤ}_{u∈{1, . . . , U}}; and
applying an inverse precoder for each of the sets comprising DAFT-domain symbols to generate U sets of estimated symbols, the inverse precoder comprising a Mᵤ-point inverse discrete affine Fourier transform (IDAFT), based on chirp carriers the phase of each of which is a bivariate polynomial of DAFT-domain symbol index and time index, the bivariate polynomial comprising a first quadratic term of the time index and a second quadratic term of the DAFT-domain symbol index, the first quadratic term of the time index and the second quadratic term of the DAFT-domain symbol index being associated with the same coefficient c.

17. The method according to claim 16, further comprising receiving an indication of at least one of the system parameter and the channel parameter with the signal.

18. The method according to claim 16, wherein at least one of the U sets comprising Mᵤ DAFT-domain symbols also comprises Rᵤ transform-domain pilots symbols, the method (600) comprising equalizing the corresponding Mᵤ DAFT-domain symbols using the Rᵤ transform-domain pilots symbols prior to applying the inverse precoder.

19. The method according to claim 16, wherein the signal comprises, for at least one set of Mᵤ received symbols, a set of Rᵤ DAFT-domain pilot symbols, the method comprising equalizing a corresponding set of Mᵤ DAFT-domain symbols using the Rᵤ DAFT-domain pilot symbols prior to applying the inverse precoder.

20. The method according to claim 16, further comprising removing a chirp periodic prefix or a cyclic prefix from the received signal prior to applying the N-point DAFT to generate the U sets comprising Mᵤ DAFT-domain symbols.
